(19) United States
(12) Patent Application Publication
(10) Pub. No.: US 2008/0144033 A1
(43) Pub. Date: Jun. 19, 2008

(54) OPTICAL LEVEL DETECTION PROBE FOR FLUID OVERFILL PREVENTION SYSTEM

(75) Inventor: Nicholas P. Milo, Saugus, MA (US)

Correspondence Address: LAW OFFICES OF PAUL E. KUDIRKA, 40 BROAD STREET, SUITE 300, BOSTON, MA, 02109, US

(73) Assignee: Scully Signal Company, Wilmington, MA (US)

(21) Appl. No.: 11/610,136

(22) Filed: Dec. 13, 2006

(51) Int. Cl. G01N 21/55

(52) U.S. Cl. 356/445

(57) ABSTRACT

A high-reliability, high-temperature liquid level detection probe uses a metal ring to hold a level detection prism in the probe body. The metal ring forms an interference fit with both the prism and the probe body and the metal/prism and metal/metal seals remain effective even at elevated temperatures so that contamination of the probe electronics is prevented. The probe electronics and the circuit board on which the electronics are mounted are enclosed in a holder so that the potting compound which is used to seal the electrical wires entering the probe does not contact the electronics or the circuit board. Thus, the circuit board and electronics are free to move in response to expansion and contraction of the potting compound and damage to the electronics and circuit board is prevented.

### BACKGROUND

This invention relates to fluid transfer control apparatus and, particularly, to optical overfill probes that detect when fluid being transferred into a container has reached a predetermined level and prevent overfill of the container. In the art of fluid transfer control, particularly as it applies to the petroleum industry, one of the more common control devices is an overfill sensor for determining when the fluid being transferred into a container, such as a petroleum tanker truck compartment, has reached a predetermined level. An output signal from such a probe indicates when the fluid has reached the predetermined level, and may be used as an indication by a fluid transfer controller to discontinue fluid flow into the compartment. In this way, overfilling of the compartment, which is particularly hazardous when dealing with flammable liquids such as gasoline, can be avoided. Such a probe 100 is shown schematically in FIG. 1, which shows a partial cross-section diagram of a tanker truck compartment 104, which is being filled with a fluid 104. The probe 100 is connected by wires 108 to an overfill prevention circuit, which is not shown in FIG. 1. Typically, a well 106 is formed around the top of probe 100 in order to contain any fluid 104 that might leak out around the probe 100.

One type of overfill probe which is particularly common in the petrochemical industry makes use of an optical signal generated by a light source, such as a light emitting diode, which signal is coupled into a medium having a relatively high index of refraction, such as a glass or translucent plastic. This medium is specially-shaped and commonly referred to as a “prism.” The prism is shaped to cause internal reflection of the optical signal when surrounded by air. The shape of the prism and the direction at which the optical signal is coupled into the prism is such that the reflection of the optical signal within the prism redirects the signal toward a photodetector. This photodetector generates an output signal which indicates that the optical signal is being detected.

A schematic illustration of this prior art probe design 200 is shown in FIG. 2. In the plane of the optical signal path 202, the prism 204 has a triangular cross section. The optical signal is generated by light source 206. When the prism 204 is surrounded by air, the optical signal is reflected at two interfaces between the prism material and the surrounding air, and redirected toward photodetector 208 following the path 202. The photodetector 208 generates an electrical output signal which indicates that the optical signal is being detected.

When the fluid 104 in the compartment 102 rises high enough to contact a prism surface at a location where the optical signal is incident, the prism/air interface becomes a prism/fluid interface, and the fluid has an index of refraction much closer to the prism material than does air. According to Snell's law of refraction, (well-known in the art of optical design) the angle of incidence of the optical signal at the prism/fluid interface now results in the transmission of the optical signal through the interface due to the similarity of the relative indices of refraction. As a result, the signal is no longer detected by photodetector 208, and the corresponding change in the photodetector output signal is detected by conventional signal processing electronics (not shown in FIG. 2) and used to discontinue loading of the compartment 102.

One of the problems encountered with a prior art probe 200, a portion of which is shown in FIG. 2, is related to contamination of the probe by fluids. In particular, the well 106 (FIG. 1), which is meant to contain fluid spills, may trap petroleum fluids or water. Over time, the trapped fluid can infiltrate the probe 100, typically along the electrical wires 108 attached to the probe 100. If the fluid reaches the signal processing electronics, it can cause a malfunction. In addition, the prism 204 is conventionally surrounded by a housing, or body, 210 which fits tightly against the outer surface of the prism. Nonetheless, vapors from the fluid product that fills the truck compartment eventually pass between the housing 210 and the prism 204, as shown by arrow 214, and either contaminate the source 206 and photodetector 208 or cause a malfunction in the electronics. This problem is exacerbated by high temperatures. Such high temperatures could occur when a truck compartment is being cleaned, for example, by a steam cleaning mechanism.

In an attempt to overcome these contamination problems, various sealing techniques have been used. In particular, in order to prevent trapped fluid from infiltrating the probe along the electrical wires, the probe body is typically filled with a potting compound, such as an epoxy compound 212, which bonds to the probe body, the circuit board and the electronic components. This forms an effective seal, but causes other problems. In particular, the signal processing electronics are typically mounted on a glass-filled nylon circuit board whose thermal expansion coefficient differs significantly from the thermal expansion coefficient of the potting compound. Over time, the difference in the expansion coefficients can pull electronic components off of the circuit board or separate the connection wires from the circuit board, causing failure of the electronics.

In addition, in order to prevent leakage of fluid vapors between the probe body 210 and the prism 204, the prism 204 is affixed to the body 210 with potting compound 218 and an elastomeric seal 216 is sometimes placed behind the prism 204. However, due to differential expansion and contraction, the potting compound and seals are not effective and eventually leakage occurs, which, as described above, is exacerbated by high temperatures.

A failure of the probe can cause a false overfill signal to be generated, which prevents fluid from being loaded into the compartment, despite the fact that the compartment may be empty. If this happens, it may be necessary to clean or replace the probe in the field resulting in significant downtime. Alternatively, a dangerous overfill situation can occur when the contact of the prism by the fluid goes undetected, and the compartment continues to be filled to the point of overflowing.

### SUMMARY

In accordance with the principles of the present invention, a high-reliability, high-temperature overfill prevention probe uses a metal ring to hold the prism in the probe body. The metal ring forms an interference fit with both the prism and the probe body and the metal/prism and metal/metal seals remain effective even at elevated temperatures so that contamination of the electronics is prevented

In another embodiment, the electronics and the circuit board on which the electronics are mounted are enclosed in a holder so that the potting compound which is used to seal the electrical wires entering the probe does not contact the electronics or the circuit board. Thus, the circuit board and electronics are free to move in response to expansion and contraction of the potting compound and damage to the electronics and circuit board is prevented.

### BRIEF DESCRIPTION OF THE DRAWINGS

FIG. 1 is a partial cross-sectional diagram of a conventional tanker truck compartment showing a typical placement of an overfill prevention probe in the compartment.

FIG. 2 is a partial cross-sectional diagram of a conventional overfill prevention probe showing the manner of attaching the prism to the probe body.

FIG. 3 is a partial cross-section diagram of an overfill prevention probe constructed in accordance with the principles of the present invention.

FIG. 4 is a cross-section diagram of the probe taken along sectional lines A-A in FIG. 3 showing the electronics and circuit board holder.

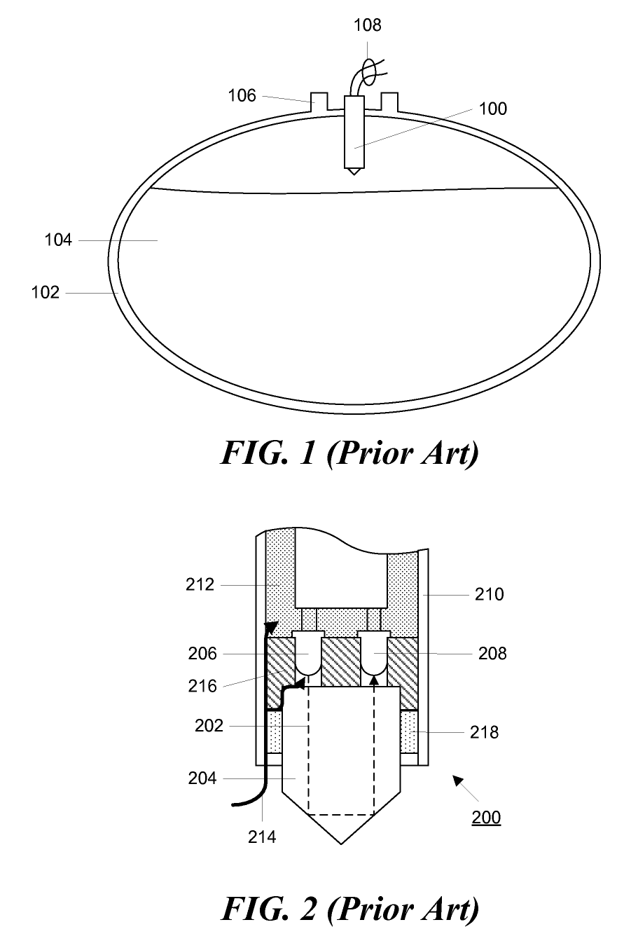

### DETAILED DESCRIPTION

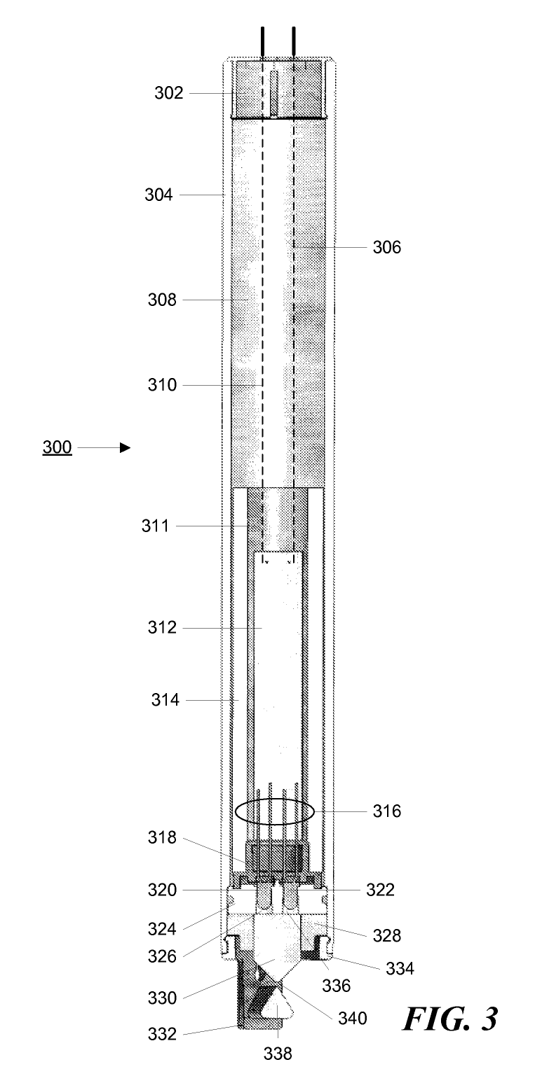

FIG. 3 shows a high-reliability, high-temperature probe 300 in which a prism 330 is mounted in the probe body 304, which illustratively may be composed of aluminum or stainless steel, by means of a metal retention ring 328, which may also illustratively be composed of aluminum or stainless steel. Metal retention ring 328 is sized so that prism 330 must be inserted into the ring 328 by pressing it into ring 328 thereby forming an interference fit. In order to allow the probe to operate at elevated temperatures, for example, 212° F. (so that the probe will not be harmed if the compartment in which it is mounted is steam cleaned) it is advantageous to heat metal ring 328 before the prism 330 is press-fitted into the ring. This procedure insures that the ring 328 will retain the prism 330 even at elevated temperatures. After the prism 330 has been pressed into ring 328, the prism/ring combination is pressed into the probe body 304 thereby forming an interference fit between ring 328 and body 304. The interference fits between the prism 330 and the ring 328 and between the ring 328 and body 304 insure that no vapors can pass thereby and contaminate the electronics.

Behind the ring 328 and prism 330, a front spacer 324 and a back spacer 318 are positioned. Both of these spacers may be made from an elastomeric material, such as Viton® (trademark of Dupont Performance Elastomers, Inc.) Front spacer 324 positions and cushions the light source 320 and the photodetector 322. Holes 326 and 336 allow light to pass from, and to, these devices and the prism 330. Back spacer 318 positions and holds the electrical leads 316 extending from the light source 320 and the photodetector 322.

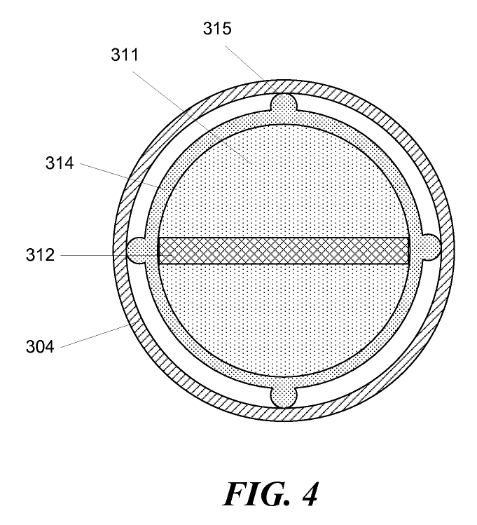

In one embodiment, the circuit board 312 is enclosed within a tubular carrier 314, which may be composed of a glass-filled, polycarbonate material. This carrier is also shown in the cross section view of FIG. 4. Four semi-circular ribs 315 extend longitudinally along the carrier outer surface in order to evenly space the carrier 314 within the probe body 304. In order to further seal and protect the electronic parts, the carrier 314 may be filled with a compliant, electrically insulating material, such as a conventional silicon gel 311.

The reminder of the probe body 304 is filled with a conventional potting material 308 which surrounds and seals the electrical wires 306 and 310 that extend through the end cap 302 out the back of the probe body 304.

Probe 300 is also provided with a prism guard 332. Prism guard 332 not only physically protects prism 330, but also prevents the buildup of liquid on the surface of the prism 330 that results from vapor condensation. The liquid buildup can cause leakage of the optical signal through the surface of the prism, despite the fact that the prism is not in contact with fluid in the compartment. If the leakage is significant enough, the amount of light detected by the photodetector can drop below the overfill detection threshold and result in premature termination of a filling operation. In order to prevent liquid buildup, prism guard 332 has a bar 338 located close to the lowest part 340 of prism 330. This draws liquid off the prism via surface tension and prevents the liquid buildup from causing a malfunction. For high temperature operation, the prism guard 332 can be made of aluminum or stainless steel and designed to screw into a threaded groove 334 in the probe body 304. For lower temperature operation, the guard 332 can be made of a polymeric material and designed to snap into groove 334.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. An optical level detection probe for a fluid overfill prevention system, the probe having a light source, a photodetector and electronic signal processing components, comprising:
a hollow probe body enclosing the light source, the photodetector and the electronic signal processing components;
a prism that redirects light from the light source to the photodetector; and
a metal retention ring into which the prism is press-fitted and which is press-fitted into the probe body.

2. The probe of claim 1 wherein the metal retention ring is fabricated from aluminum.

3. The probe of claim 1 wherein the metal retention ring is fabricated from stainless steel.

4. The probe of claim 1 wherein the electronic signal components are enclosed in a hollow carrier which is positioned inside the hollow probe body.

5. The probe of claim 4 wherein a portion of the hollow probe body is filled with a potting compound which is excluded from inside the carrier.

6. The probe of claim 4 wherein the carrier is separated from the hollow probe body by a plurality of spacing ribs located on an exterior of the carrier.

7. The probe of claim 4 wherein the carrier is filled with a compliant insulating material.

8. The probe of claim 7 wherein the electronic signal processing components are mounted on a printed circuit board and the printed circuit board is enclosed within the carrier and wherein the compliant insulating material surrounds the printed circuit board.

9. A method for fabricating an optical level detection probe for a fluid overfill prevention system, the probe having a light source, a photodetector and electronic signal processing components, the method comprising:
(a) enclosing the light source, the photodetector and the electronic signal processing components in a hollow probe body;
(b) press-fitting a prism that redirects light from the light source to the photodetector into a metal retention ring; and
(c) press-fitting the metal retention ring and the prism into the probe body.

10. The method of claim 9 wherein step (b) comprises fabricating the metal retention ring from aluminum.

11. The method of claim 9 wherein step (b) comprises fabricating the metal retention ring from stainless steel.

12. The method of claim 9 wherein step (a) comprises enclosing the electronic signal components in a hollow carrier before enclosing the electronic signal components in the hollow probe body.

13. The method of claim 12 further comprising:
(d) filling a portion of the hollow probe body with a potting compound; and
(e) excluding the potting compound from inside the carrier.

14. The method of claim 12 wherein the carrier is separated from the hollow probe body by a plurality of spacing ribs located on an exterior of the carrier.

15. The method of claim 12 further comprising:
(d) filling the carrier with a compliant insulating material.

16. The method of claim 15 wherein step (d) comprises mounting the electronic signal processing components on a printed circuit board, enclosing the printed circuit board within the carrier and surrounding the printed circuit board with the compliant insulating material.
